(19) United States
(12) Patent Application Publication
(10) Pub. No.: US 2012/0200469 A1
(43) Pub. Date: Aug. 9, 2012

(54) STACKED ANTENNA ASSEMBLY WITH REMOVABLY ENGAGEABLE COMPONENTS

(76) Inventors: Henry Cooper, Temecula, CA (US); Sheng Peng, Lynwood, WA (US); Ron Weatberg, Temecula, CA (US); Paul Habeck, Temecula, CA (US); Floyd Phelps, Temecula, CA (US)

(21) Appl. No.: 13/369,263

(22) Filed: Feb. 8, 2012

Related U.S. Application Data
(60) Provisional application No. 61/440,744, filed on Feb. 8, 2011.
(60) Provisional application No. 61/551,150, filed on Oct. 25, 2011.

(51) Int. Cl. H01Q 13/10

(52) U.S. Cl. 343/770; 343/767

(57) ABSTRACT

An omnidirectional RF radiator element formed upon a surface of a planar dielectric substrate. The element features a plurality of cavities narrowing in cross-section and formed upon a surface of said planar substrate which narrow from a widest point to a narrowest point. Feed lines communicate with each cavity for transmission and reception of RF therethrough. Each radiator element is engageable with other elements in a stacked configuration using connectors engaged to the feed lines and configured for cooperative engagement with other connectors.

This application claims priority to U.S. Provisional Patent Application No. 61/440,744 filed on Feb. 8, 2011 and to U.S. Provisional Application 61/551,150 filed on Oct. 25, 2011 both or which are respectively included herein in their entirety by this reference.

### BACKGROUND OF THE INVENTION

1. Field of the Invention

The present invention relates to antennas for transmission and reception of radio frequency communications. More particularly the present invention relates to an omnidirectional antenna providing for wideband transmission and reception of RF signals in virtually any band of frequencies between a high and low threshold determined by the antenna configuration. The disclosed device is adaptable especially well to WiFi, cellular bands, Bluetooth, and high definition television frequency reception and transmission.

2. Prior Art

External antennas generally take the form of large cumbersome conical, elongated, or Yagi type construction and are placed outdoors either on a pole on the roof top of the building housing the receiver or in an attic or the like of a building. These antennas are somewhat fragile as they are formed by the combination of a plurality of parts including reflectors and receiving elements formed of light weight aluminum tubing or the like having various lengths to satisfy the frequency requirements of the received signals and plastic insulators. The conventional receiving elements are held in relative position by means of the insulators and the reflectors elements are grounded together. Similar configurations are required for other frequencies such as cellular bands and Wifi and the like.

Assemblage of these antennas is required either by the user, which may bend or break some of the elements during construction which must be replaced or become injured by falling or the like or by an installer for hire, either of which increase the already high economic cost of the antenna.

Externally placed antennas of this type are continually subjected to the elements. Even if not damaged or destroyed by the elements during harsh weather conditions over time these antennas will generally produce poor reception or reduced reception during extreme weather conditions or will gradually reduce their ability to produce acceptable reception over time due to mechanical decay. In addition to the above deficiencies, this type of receiving antenna is aesthetically ugly.

Other antennas which are currently used, such as indoor antennas, may be easy on the eyes, but are generally unacceptable for producing a good picture and sound. The most common and effective of these indoor antennas is the well known dual dipole type positioned adjacent to or on the television receiver and commonly referred to as “rabbit ears”. These antennas are generally ineffective for fringe area reception and are only effective for strong local signal reception. When low frequency signals reception is desired, the dipoles must be extended to their maximum length which makes the “rabbit ear” antenna susceptible to tipping over or interfering with or causing possible damage to any adjacent objects. Other indoor and outdoor antennas are employed for other reasons such as WiFi networks, Bluetooth communications, and cellular communications.

The present invention relates to high gain antennas, and more particularly to planar omnidirectional antennas formed of a single planar conductive substrate and capable of being vertically stacked for additional gain through the employment of coaxial connections and threaded or bayonet or other means for stacked removable engagement.

2. Prior Art

Since the inception of digital television transmission, high definition television (HDTV) service providers have had the task of installing a plurality of antenna sites over a geographic area to establish cells for communication with HDTVs located in the cell. From inception to the current mode of digital broadcasting and reception, providers have each installed their own antenna sites, resulting in a plurality of large external antennas broadcasting signals from different positions.

Generally, antennas adapted to the broadcast frequencies, or cable hookup, is necessary to provide a television receiver with the required signal strength to provide a perfect picture and sound to the viewer. Because different broadcasters may own broadcast antenna sites, this can result in a plurality of different broadcast sites from such broadcasters in different geographic positions in a television market. Since a conventional antenna works best when pointed toward a broadcast site, multiple geographic sites result in a problem for viewers wishing to use an antenna.

The location of such sites can greatly affect the reception gain of HDTV service to the paying customers. Low gain at the receiving antenna essentially means a bad reception of HDTV picture. In order to satisfy customer needs, providers may result in constructing additional and often unsightly antenna sites. Alternatively, a higher gain antenna may be employed on the receiving end.

Additionally, other digital signals are employed for a wide variety of technologies. A few include cell phones, emergency communications, commercial communications, and Wifi and Bluetooth configurations for tablet computers and other electronic components. The different services may employ a wide variance of frequencies, from a plurality of incoming and outgoing directions, to communicate the digital signal to users.

When constructing a communications array such as an HDTV antenna broadcast site, or a wireless communications grid, or

WiFi or other communications grid, the builder is faced with the dilemma of obtaining antennas that are customized by providers for the narrow frequency to be broadcast for various individual digital signals. Most such antennas are custom made using antenna elements, such as dipole elements, to match the narrow band of frequencies to be employed at the site which can vary widely depending on the network and venue. As such it is also desirable that the antenna provides wide bandwidth performance.

Antenna stacking, such as with multiple dipole or yagi elements, has shown to both aid in increasing reception gain as well as maintaining performance within a wide bandwidth. However, such systems suffer severe signal timing issues and lack broadband capability. Vertical antenna stacking, in which a plurality of antennas are mounted onto a common mast shows some improvement in gain and vertical directivity. Prior art has shown attempts to provide stacked antenna systems with high gain and wideband transmission.

U.S. Pat. No. 5,124,733 to Haneishi teaches a stacked micro-strip antenna that attains double channel duplex characteristics with utilizing the coupling between a first radiating element and a second radiating element. However, Haneishi does not teach a convenient means to removably engage additional antennas as would be desired for increased gain.

U.S. Pat. No. 5,534,880 to Button et al. teaches a omnidirectional high gain antenna employing a plurality of stacked biconical radiator antenna structures. Although Button maintains high gain over the entire omnidirectional azimuth plane the device is in general bulky and requires a keen knowledge of antenna systems to properly electrically engage the plurality of radiator elements. Furthermore, this and many other prior art stack antenna systems do no teach a means to allow for convenient removable engagement of the radiator elements, nor the ability to configure the antenna element from a single planar conductor with a plurality of wideband receiving cavities communicating a broad spectrum of signals to and from the element from multiple directions.

As such there is a continuing and unmet need for an compact high gain antenna element capable of wideband communications concurrently. Such a device should be easily manufactured and produced enhanced reception and transmission through being formed of a single planar conductor. Such a device should provide a plurality of reception cavities covering the entire area around the center of the antenna. Further, such a device should be adaptable for easy vertical stacking to provide an easy means to enhance gain, or to add additional frequency ranges to the formed antenna from multiple elements. The overlapping radiation/reception pattern of the stacked radiator elements of the device should provide omnidirectional coverage in 360 degree azimuth. The device should be void of problems normally encountered in using multiple antenna elements such as ghosting. Furthermore the device should provide a means for removable engagement of one or a plurality of the individual radiator elements as desired for frequencies employed and desired gain. Still further, such a device should allow for configuration of the elements, to send and receive a broad band of communications between a high and low frequency, multiple antennas available to cover the entire spectrum if desired.

### SUMMARY OF THE INVENTION

The device and method herein disclosed and described achieves the above-mentioned goals through the provision of a radiator antenna element array which is uniquely shaped to provide excellent transmission and reception capability in a wideband of frequencies which is only limited by the size of the antenna element. Each element covers a wideband of frequencies for transmission and reception between a determined high, and low frequency. The device can thus be configured to receive and transmit in broadbands between a high and low frequency, virtually anywhere across the spectrum between 30 Hz to 3000 Khz. Those skilled in the art will realize that the size of the element will be the determining factor and any element formed as herein to receive and transmit across a range in the spectrum is anticipated herein.

Currently omnidirectional elements have been configured to for transmission and reception for conventional and HDTV frequencies between 54 Mhz to 1002 Mhz. Such provide excellent omnidirectional signal receipt and are stackable to enhance gain. Further, larger or smaller elements may be placed in the engaged stack, to provide reception in other frequency bands determined by the widest and narrowest portion of the cavity formed on the elements.

Elements formed for the range between 470-860 MHZ, provide excellent performance with a measured loss below −9.8 db which means that the Voltage Standing Wave Radio is 2:1 over this entire frequency band. Elements formed in the 680 MHz to 2100 MHZ band, the radiator element can concurrently provide excellent performance with a measured return loss of less than −9.8 dB. Similar concurrent performance characteristics are achieved in the bandwidth between 2.0 GHz to 6.0 Ghz. Consequently, the single radiator element herein disclosed, may be formed to be easily capable of concurrent reception and transmission in frequencies from 470 MHz to 5.8 GHz, can be coupled, and easily matched for inductance in an array coupling effect, and can provide the wideband communications reception and transmission. Depending on the size of the formed element, as noted, any frequency range desired by a user is achievable between a high and low point determined by the construction of the mouth and cavity of the element.

The radiator element array of the instant invention is based upon a planar antenna element formed by printed-circuit technology. The antenna is of two-dimensional construction forming what is known as a Vivaldi horn or notch antenna type. The array is formed on a dialectic substrate of such materials as MYLAR, fiberglass, REXLITE, polystyrene, polyamide, TEFLON, fiberglass or any other such material suitable for the purpose intended. The substrate may be flexible whereby the antenna can be rolled up for storage and unrolled into a planar form for use. Or, in a particularly preferred mode of the device herein, it is formed on a substantially rigid substrate material in the planar configuration thereby allowing for components that both connect, and form the resulting rigid antenna structure.

The antenna radiator element itself, formed on the substrate, can be any suitable conductive material, as for example, aluminum, copper, silver, gold, platinum or any other electrical conductive material suitable for the purpose intended. The conductive material forming the element is adhered to the substrate by any known technology.

In a particularly preferred embodiment, the antenna radiator element conductive material coating on a first side of the substrate is formed with a non-plated first cavity or covered surface area, in the form of a horn. In a particularly preferred mode the antenna array four mouths with curvilinear cavities in a single planar layer of conductive material to form four such radiator elements. The formed array has the general appearance of a cross-section of a “four leaf clover” with two half-leaf sections per element, in a substantially mirrored configuration, extending from a center to substantially rounded ends positioned a distance from each other at their respective distal ends.

A cavity beginning with a mouth area is formed with a large uncoated or unplated surface area of the substrate between the two halves, forms a mouth of the a single antenna element and is substantially centered between the two distal substantially round ends on each leaf or half-section of the shaped radiator element. The cavity extends substantially perpendicular to an imaginary horizontal line running between the two distal rounded ends and then curves substantially into the body portion of one of the leaf halves and extends away from the other half.

Along the cavity pathway, from the distal rounded ends of the element halves, the cavity narrows slightly in its cross sectional area. The cavity is at a widest point between the two rounded ends and narrows to a narrowest point. The cavity from this narrow point curves to extend to a distal end within the one leaf half, where it makes a short right angled extension from the centerline of the curving cavity.

The mouth, or widest point of the cavity, at the furthest point from the narrow end of the cavity, between the distal ends of each radiator halves, determines the to low point for the frequency range of the element. The narrowest point of the cavity between the two sides or halves. determines the highest frequency to which the element is adapted for use. Of course those skilled in the art will realize that by adjusting the widest and narrowest distances of the formed cavity, the element may be adapted to other frequency ranges, and any antenna element which employs two substantially identical leaf portions to form a cavity therebetween with maximum and minimum widths is anticipated within the scope of the claimed device herein.

On the opposite surface of the substrate from the formed radiator element array, feedlines extend from the area substantially central and passes through the substrate to a tap position to electrically connect with each radiator element which has the cavity extending therein to the distal end perpendicular extension.

The location and width of the feedlines and connection, the size and shape of the two halves of the radiator element, and the cross sectional area of the cavity, may be of the antenna designer's choice for best results for a given use and frequency. However, because of the disclosed radiator element performs so well and across such a wide bandwidth, the current mode of the radiator element as depicted herein, with the connection point shown, is especially preferred. Of course those skilled in the art will realize that shape of the half-portions and size and shape of the cavity may be adjusted to increase gain in certain frequencies or for other reasons known to the skilled, and any and all such changes or alterations of the depicted radiator element as would occur to those skilled in the art upon reading this disclosure are anticipated within the scope of this invention.

The radiator element array as depicted and described herein performs admirably across many frequencies and spectrums employed in HDTV reception. Currently performance is shown by testing to excel in a range of frequencies including but not limited to 200 Mhz, 700 MHz, 900 MHz, 2.4 GHz, 3.5 GHz, 3.65 GHz, 4.9 GHz, 5.1 GHz and 5.8 GHz with bandwidth capabilities experimented up to 1.2 gbps. Such a wide range in the RF spectrum from a single radiator element and the array as depicted, is unheard of, prior to this disclosure.

Further the particular shape of the planar radiator element as depicted provides an improved means for weather proofing as is often desired with outdoor TV antennas, or indoors for WiFi and Bluetooth. The device can easily engage into a similarly shaped housing or similar structure for outdoor use in all weather.

With respect to the above description, before explaining at least one preferred embodiment of the herein disclosed invention in detail, it is to be understood that the invention is not limited in its application to the details of construction and to the arrangement of the components in the following description or illustrated in the drawings. The invention herein described is capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the pioneering conception of such a radiator element array formed on a substrate and with a cavity between two halves to yield a wide RF band coverage upon which this disclosure is based, may readily be utilized as a basis for designing of other antenna structures, methods and systems for carrying out the several purposes of the present disclosed device. It is important, therefore, that the claims be regarded as including such equivalent construction and methodology insofar as they do not depart from the spirit and scope of the present invention.

It is particularly preferred that the planar bodies of the antenna elements further include a means to removably engage an additional antenna element in a vertical stack arrangement. The means for engagement is preferably located substantially central in the array of radiator elements. In addition, the engagement means acts as a means to electrically connect the array of feedlines of the first planar antenna element to the engagement means and subsequent array of feedlines of the additional stacked elements. Consequently, the means of engagement of the first and subsequent stacked antenna elements is an in-line common vertical mast for electrical RF transmission of all antenna elements in the stacked antenna of the present invention. The means of engagement may be screw type, snap fit, or permanent engagement.

One common principle of stacked antennas involves the difference in phase of the combining signals. Furthermore, the initial arrival time of the signals intercepted by the antenna combination to the common mast must be considered. The former is easily alleviated since each antenna element is substantially similar while it is particularly preferred that the distance of the feedlines from the radiator elements to the means of engagement, i.e. in-line common mast, is uniform throughout, providing that the signals received from each antenna element reach the vertical mast at the same time.

However, it is the physical vertical spacing of the stacked antenna elements that effects the phase combination of the RF signals traveling down the mast. As a result it is particularly preferred that the means of engagement provide a separation spacing of ¼ to ½ of the principal wavelength of the antenna elements. As such, the combining signals of, for example, a first, second, and third antenna element will be each ¼ to ½wavelength in phase allowing combination without cancellation. As previously mentioned, it is of a great advantage of stacked antenna assemblies to provide increased gain. In a stacked structure, the addition of a second antenna element to a single element alone provides a combined unitary stacked antenna structure that is essentially double the gain of a single antenna element. However, the addition of a third antenna element does not simply triple the gain. Instead the gain is increased by 50%, since addition of the third element constitutes the addition of only one half of the combined elements in the unitary structure. As such, the addition of a fourth antenna element will constitute an additional 33.33% increase in gain from that of the three element structure, since the single fourth antenna element is only ⅓ of the previous combined three element structure, and so on.

It is one principal object of this invention to provide an antenna radiator element array which transmits and receives radio waves across a wide array of frequencies.

It is a further object to provide an omnidirectional antenna element for transmission and reception across a wide band, and in particular HDTV transmission and reception, WiFi, and Bluetooth.

It is an object of this invention to provide an antenna that may be constructed with a weatherproof housing or covering for employment in all weather.

It is an additional object of this invention to provide such an antenna providing improved performance characteristics never before seen in the art.

These together with other objects and advantages which become subsequently apparent reside in the details of the construction and operation as more fully hereinafter described and claimed, reference being had to the accompanying drawings forming a part thereof, wherein like numerals refer to like parts throughout.

With respect to the above description, before explaining at least one preferred embodiment of the herein disclosed invention in detail, it is to be understood that the invention is not limited in its application to the details of construction and to the arrangement of the components in the following description or illustrated in the drawings. The invention herein described is capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other structures, methods and systems for carrying out the several purposes of the present disclosed device. It is important, therefore, that the claims be regarded as including such equivalent construction and methodology insofar as they do not depart from the spirit and scope of the present invention

### BRIEF DESCRIPTION OF DRAWING FIGURES

FIG. 1 depicts a top plan view of the preferred mode of the antenna array of four radiator elements herein shaped similarly to a “four leaf clover” positioned on a substrate showing the substantially rounded distal ends forming the widest point of the cavity “W” which narrows to a narrowest point “N” at a position substantially equidistant between the two distal rounded ends.

FIG. 2 is a rear view the omnidirectional antenna radiator device showing the array of communication feedlines corresponding to the radiator elements.

FIG. 3 shows again another top view as in FIG. 1, with the rear engaged feedlines shown in dashed lines.

FIG. 4 is a top plan view of a radiator element of the device herein showing a coaxial connector positioned in electronic engagement with the feedlines and adapted to engage mating connectors.

FIG. 5 depicts a side view of the device of FIG. 4, showing a cover to protect the radiator element.

FIG. 6 depicts a side view of a possible as-used mode of the device showing a plurality of radiator elements, or a single or multiple sizes, engaged and vertically stacked.

### DETAILED DESCRIPTION OF THE PREFERRED EMBODIMENTS OF THE INVENTION

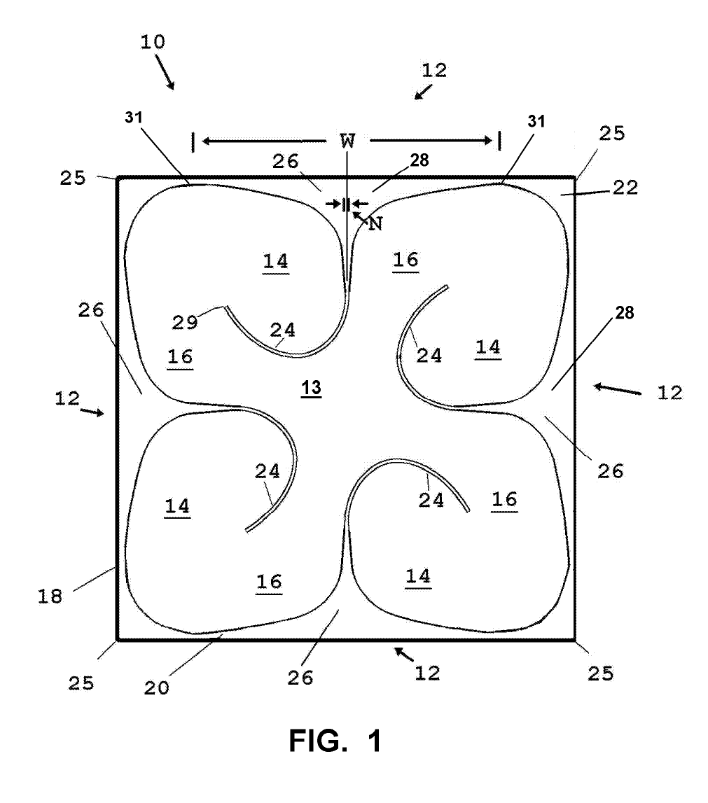

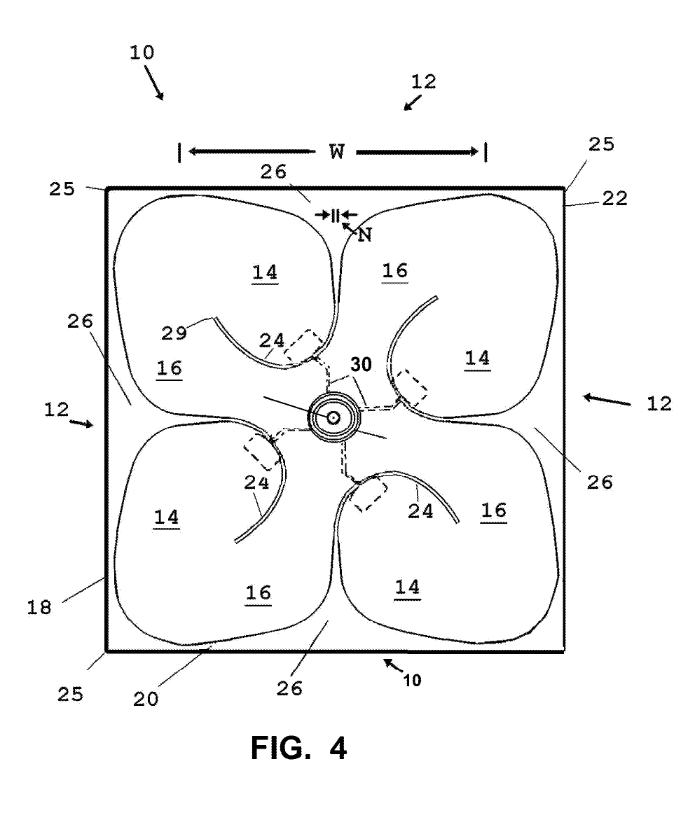

Now referring to drawings in FIGS. 1-6, wherein similar components are identified by like reference numerals, there is seen in FIG. 1, a single radiator element 12 configured for individual or singular use although it can also be configured in other fashions such as in FIG. 4, for a removable engagement with one or more additional antenna radiator elements 12 of this device 10. A favored array formation, which minimizes timing problems is shown in FIG. 6, which shows an array of four radiator elements 12. As noted, in such an array, all of the radiator elements 12 may be configured the same, that is having a widest point W and narrowest point N (FIGS. 1 and 4) adapted to the same frequency range. Or, the array may have one or a plurality of identical radiator elements 12, and can have other elements sized to transmit and receive on different frequency ranges between a high and low frequency.

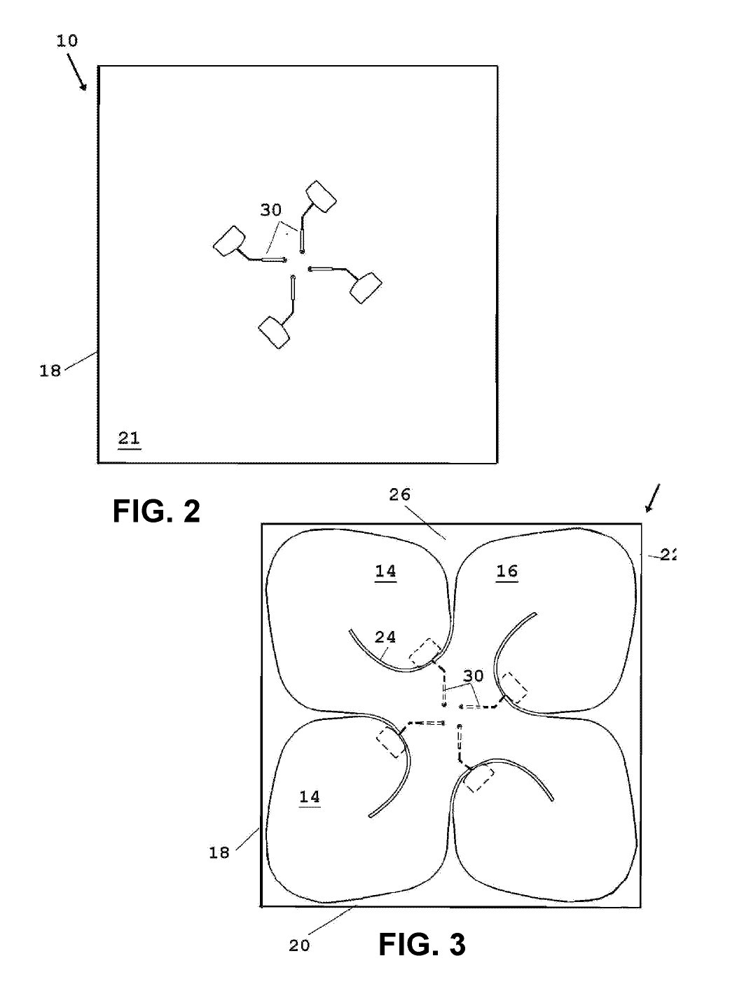

Of course even in the singular radiator element 12 of FIG. 1, when engaged to the appropriate electronic component using the feedlines 34 of FIGS. 2 and FIG. 3, provides enhanced omnidirectional transmission and reception. The formation of the radiator element 12 from a single planar piece of conductive material such as copper, provides exceptional reception and transmission capability due to the impedance matching provided by the configuration of such a single planar sheet and the formed openings for the mouth and curvilinear cavity 24 formed in the conductive material 13, which may be adjusted in length for such impedance matching.

Formed to an array of radiator elements 12, such as in FIG. 6, each radiator element 12, is preferably formed from the single piece of planar conductive material 13, such as copper, on a dielectric substrate 25. Such a non conductive substrate 25 may be constructed of for instance either a rigid or flexible material such as, MYLAR, fiberglass, REXLITE, polystyrene, polyamide, TEFLON fiberglass, or any other dielectric material which would be suitable for the purpose intended.

Each individual radiator element 12 is depicted having two opposing similarly shaped half sections which are formed by a first lobe 25 and second lobe 16 having edges descending into the mouth having edges substantially identical or mirror images of each other. The antenna comprised of the plurality of radiator element 12 is preferably comprised of four or more radiator elements 12 with four depicted merely for demonstrative purposes and should not be considered limiting. However, the plurality of elements may be three or two if less coverage around a point is desired.

A first surface 22 shown is coated with a conductive material by microstripline or the like or other metal and substrate construction well known in this art. Any means for affixing the planar conductive material cut to the appropriate shape to form the lobes, to the substrate, is acceptable to practice this invention. The conductive material 13 as for example, includes but is not limited to aluminum, copper, silver, gold, platinum or any other electrically conductive material which is suitable for the purpose intended. As shown in FIG. 1 the surface conductive material 13 on the first surface 22 is etched away, removed by suitable means or left uncoated in the coating process to form the first and second lobes 14,16 and having a mouth 26 leading to a curvilinear portion of the cavity 28 forming each radiator element 12.

The cavity 28 extending from the mouth 26 has a widest point “W” and extends between the curved side edges of the two lobes 14 and 16 to a narrowest point “N” which is substantially equidistant between the depicted two distal tips 31 and which is positioned along an imaginary line substantially perpendicular to the line depicting the widest point “W” which is the distance running between the two distal tips 31 on the two lobes 14 and 16 which are at points on the edge of the lobes, furthest from a line running from the point at the curvilinear portion of the cavity 28 where there exists the narrowest gap “N” between the side edges of the lobes, before the curvilinear portion curves.

The widest distance “W” of the mouth 26 portion of the cavity 28 determines the low point for the frequency range of the radiator elements 12. The narrowest distance “N” opposite the mouth 26 portion of the cavity 28 between the two lobes 14 and 16 determines the highest frequency to which the radiator element 12 is adapted for use. Of course, those skilled in the art will realize that by adjusting the widest and narrowest distances of the formed cavity, the element may be adapted to other frequency ranges and any antenna element which employs two substantially identical leaf portions to form a cavity therebetween with maximum and minimum widths is anticipated within the scope of the claimed device herein.

The cavity 28 formed by a void in the conductive material 13 forming the lobes, proximate to the narrowest distance “N”, curves into the body portion of one lobe, such as the first lobe 14, and extends away from the opposing lobe 16. The cavity 28 extends along the curvilinear portion, to a distal end 29 within the first lobe 14 where it makes a short right angled extension away from the centerline of the cavity 28 and toward the centerline of the mouth 26. This short angled curvilinear portions, is adjustable in length as a means for tuning the radiator element 12 for impedance, and has shown to provide improvement in gain for some of the frequencies and adjustment of the extension length extending in the curve from the cavity 28 area, provide a means for impedance matching for radiator element 12.

On the opposite surface 21 of the substrate 25 shown in FIG. 2, an array of feedlines 30 extend from the area of the cavity 28 intermediate to the two lobes 14 and 16 forming the two halves of the radiator element 12 and passes through the substrate 25 to electrically communicate with the first lobe 14 adjacent to the curved edge defining the curved portion of the cavity 28 past the narrowest distance “N.”

The location of the feedlines 30 connection, the size and shape of the two lobes 14 and 16 of the radiator element 12 and the cross sectional area of the widest distance “W” and narrowest distance “N” of the cavity 28 may be of the antenna designers choice for best results for a given use and frequency range between high and low. However, because the radiator elements 12 perform so well and across such a wide bandwidth, the current mode of the radiator element 12, as depicted herein with the connection point shown, is especially preferred.

The feedlines 30 may be electrically engaged with the connector 17 such as a bayonet or threaded coaxial connector, which provides a means for removable engagement to a lead wire or to another complimentary configured element 12 of a stacked array such as in FIG. 6. The electrical engagement extend connector 17, as shown in FIG. 6, allows for a plurality of antenna radiator elements 12 to be engaged in a vertical stacked fashion. The radiator element 12 at the bottom of the stack, may act as a common mount to a mast for RF transmission of all engaged antenna elements 12 to an output port.

To better understand the location and orientation of the feedlines 30 relative to the cavity 28 another top plan view of the first surface 22 is seen in FIG. 3 with the feedlines 30 engaged on the second surface 23 depicted by a dashed line.

FIG. 4 as noted a top plan view of a radiator element 12 of the device 10 herein showing a connector 17 positioned in electronic engagement with the feedlines 34 and adapted to engage mating connectors 17.

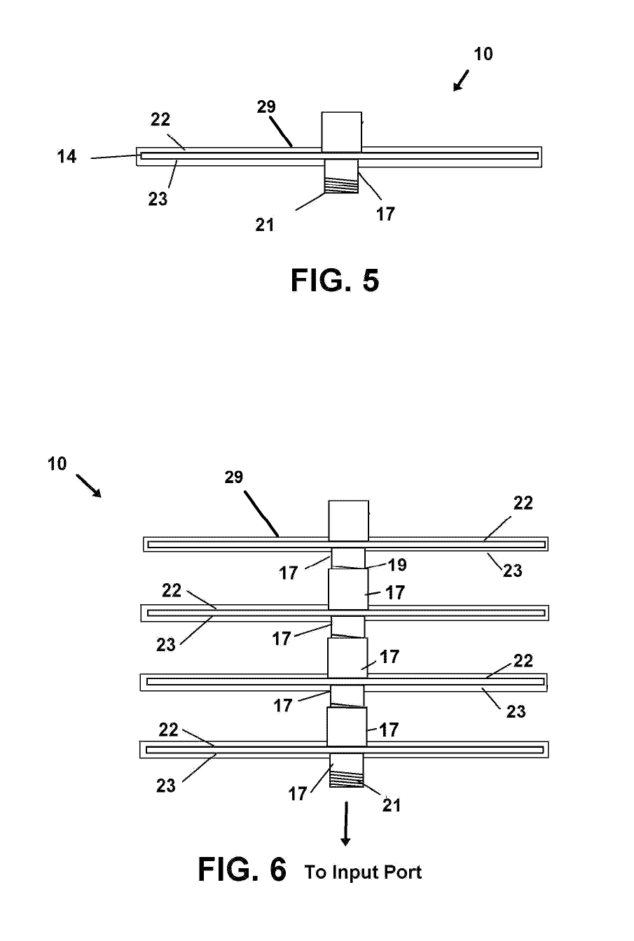

FIG. 5 depicts a side view of the device of FIG. 4, showing a cover 29 to protect the radiator element 12. FIG. 5 shows an example of a possible as-used mode of the device 10 employing four such antenna elements of the present invention. As depicted the connectors 17 of a first antenna element 10 cooperatively engages within the female connectors 17 of a subsequent antenna. As previously mention, due to the electrical engagement of the connectors 17 with the antenna feedlines 30 and electrical communication through the aperture 19 to the connectors 16, the succession of operatively engaged components of removable connectors 17 act as a common mast for RF transmission of received signals from the individual antennas to an input port as desired.

FIG. 6 depicts a side view of a possible as-used mode of the device 10 in an array, showing a plurality of radiator elements 12, or a single or multiple sizes as to widest and narrowest points determining frequency range engaged with connectors 17 using threads 19 and a coaxial connection internally, and vertically stacked.

Employed substantially central on the substrate 25 is the particularly preferred means for removable engagement including with the connector 17. The connectors 17 have a cylindrical sidewall extending from the planar surface 22 or the cover 29 and generally employ an threads 19 to engage complimentary connectors 17. A central aperture in the connectors 17 so engaged, provides a means for electrical communication between the male and female component as is operatively needed for coupled RF transmission of the subsequent stacked components, such as coaxial cable or coaxial engaging fittings.

It must be noted that the those skilled in the art will appreciate various other means to achieve removable engagement within the scope of the present invention. The particularly preferred mode of removable engagement as set forth previously is done merely for the simplest descriptive purposes. An alternate means for removable engagement may be, but is not limited to, snap-fit type engagement. Therefor the depictions and description set forth in this disclosure shall not be considered limiting in that the components for removable engagement are capable of various other types and constructions and are anticipated in this disclosure.

What is claimed is:

1. A radiator element comprising:
a dielectric substrate;
a first substrate surface of said substrate, a portion of which is covered with a conductive material and a portion of which is uncovered;
a plurality of cavities within said uncovered material, said cavities defined by respective edges of said conductive material formed upon adjoining lobes of said conductive material;
each said first cavity having a mouth portion, said mouth portion beginning at a first edge along a line extending between two points located upon opposing said lobes along respective said edges of said conductive material forming said respective lobes;
each said cavity reducing in cross-section as it extends from said first edge to a narrowest point in between said adjoining lobes;
each said cavity in a curvilinear portion extending away from said narrowest point in a curved direction into one of said lobes; and
a feedline electrically communicating at a first end with one of said respective lobes of each of said plurality of cavities, each said feedline adapted at a second end for electrical communication to an RF receiver or transceiver.

2. The radiator element of claim 1, further comprising:
said plurality of cavities being four.

3. The radiator element of claim 2, further comprising:
each of said four cavities being positioned at ninety degree angles to the other of said four cavities.

4. The radiator element of claim 1, further comprising:
said plurality of lobes being four.

5. The radiator element of claim 2, further comprising:
said plurality of lobes being four.

6. The radiator element of claim 4, further comprising:
said plurality of lobes being substantially equal in area; and
said plurality of lobes having the appearance of a four leaf clover when viewed from overhead.

7. The radiator element of claim 4, further comprising:
said feed lines electrically engaged to a connector;
said connecter configured to removably engage with complementary said connectors;
said radiator element engageable to a second said radiator element to form an array for a plurality of said radiator elements;
said connector engaged with said radiator element when engaged with a said complimentary said connector engaged with said second said radiator, providing means to engage said radiator element to said second radiator element in said array; and
said array so engaged providing an increase in RF gain employable by said transceiver or said RF receiver electronically connected thereto.

8. The radiator element of claim 5, further comprising:
said feed lines electrically engaged to a connector;
said connecter configured to removably engage with complimentary said connectors;
said radiator element engageable to a second said radiator element to form an array for a plurality of said radiator elements;
said connector engaged with said radiator element when engaged with a said complimentary said connector engaged with said second said radiator, providing means to engage said radiator element to said second radiator element in said array; and
said array so engaged providing an increase in RF gain employable by said transceiver or said RF receiver electronically connected thereto.

9. The radiator element of claim 6, further comprising:
said feed lines electrically engaged to a connector;
said connecter configured to removably engage with complementary said connectors;
said radiator element engageable to a second said radiator element to form an array for a plurality of said radiator elements;
said connector engaged with said radiator element when engaged with a said complimentary said connector engaged with said second said radiator, providing means to engage said radiator element to said second radiator element in said array; and
said array so engaged providing an increase in RF gain employable by said transceiver or said RF receiver electronically connected thereto.

10. The radiator element of claim 7, further comprising:
one or a plurality of additional said radiator elements engageable to said array through employment of a respective said complimentary connector.

11. The radiator element of claim 8, further comprising:
one or a plurality of additional said radiator elements engageable to said array through employment of a respective said complimentary connector.

12. The radiator element of claim 9, further comprising:
one or a plurality of additional said radiator elements engage able to said array through employment of a respective said complimentary connector.
